(19) United States
(12) Patent Application Publication
(10) Pub. No.: US 2011/0037765 A1
(43) Pub. Date: Feb. 17, 2011

(54) METHOD FOR DISPLAYING CHANGES IN PARAMETER VALUES

(75) Inventors: Stefan Engelke, Haste (DE); Thomas Kleegrewe, Minden (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/857,137

(22) Filed: Aug. 16, 2010

(30) Foreign Application Priority Data
Aug. 14, 2009 (DE) 102009037578.3

(51) Int. Cl. G06T 11/20

(52) U.S. Cl. 345/440

(57) ABSTRACT

The disclosure relates to a method and apparatus for displaying changes in parameter values on a display surface. Two successive sampled values (P₁₁, P₁₂ and P₂₁, P₂₂) of, in each case, two parameter values (P₁, P₂) are represented as oppositely directed vectors with a common origin orthogonally with respect to a dividing line which divides the display surface and that area which is enclosed by the dividing line and the connecting lines between the respectively older sampled value (P₁₁ and P₂₁) of a parameter value (P₁, P₂) and the respectively more recent sampled value (P₁₂ and P₂₂) of the other parameter value (P₂, P₁) is highlighted.

### RELATED APPLICATION

This application claims priority under 35 U.S.C. §119 to German Patent Application No. 102009037578.3 filed in Germany on Aug. 14, 2009, the entire content of which is hereby incorporated by reference in its entirety.

### FIELD

The disclosure relates to a method and apparatus for displaying changes in parameter values on a display surface.

### BACKGROUND INFORMATION

The known art includes multimeters with a graphic display such as have been presented with the product designations Fluke 287 and Fluke 289 on the URL http://www.elektroniknet.de/home/messentesten/produkte/uebersicht/I/datenlogger/p/d/daten-logger-mit-trendanzeige/ on Nov. 12, 2007. Here, a plurality of measured values of one and the same measurement variable are represented as a trend.

It is known that diagnostic predictions for preventive maintenance can be derived from the correlation between time profiles of a suitable selection of parameter values. The derivation of a correlated trend from a plurality of discrete time profiles by subjective comparison of discrete graphics can be susceptible to errors and gives rise to non-reproducible results.

The precise evaluation of the time profiles with statistical methods and subsequent graphic display require a large amount of expenditure on computing, which is not available, in particular in loop-fed automation equipment.

### SUMMARY

A method is disclosed for displaying changes in parameter values on a display surface, comprising: successively sampling two values for each of two parameters at a first earlier time and a more recent second time; displaying the two successively sampled values of each parameter value as oppositely directed vectors having a common origin on, and orthogonal to, a dividing line which divides the display; plotting the two more recent sampled values and the two earlier sampled values on opposite sides of the dividing line, and highlighting an area which is enclosed by the dividing line and connecting lines between the earlier sampled value of one parameter value and the respectively more recent sampled value of the other parameter value and a connecting line between the earlier sampled value of the other parameter value and the respectively more recent sample valued of the one parameter value.

An apparatus is disclosed for sampling parameter values of a processing system, comprising: a sampling device which successively samples two values for each of two parameter values at a first earlier time and a later second more recent time; a display for displaying the two successively sampled values of each parameter value as oppositely directed vectors having a common origin on, and orthogonal to, a dividing line which divides the display wherein the two more recent sampled values and the two earlier sampled values are plotted on opposite sides of the dividing line, and an area which is enclosed by the dividing line and a connecting line between the earlier sampled values of one parameter value and the respectively more recent sampled value of the other parameter value and a connecting line between the earlier sampled value of the other parameter value and the respectively more recent sample valued of the one parameter value.

### BRIEF DESCRIPTION OF THE DRAWINGS

The disclosure will be explained in more detail below with reference to exemplary embodiments. In the drawings:

FIG. 1 is a basic view of an actuator drive, including an exemplary apparatus for displaying changes in parameter values;

FIG. 2 is a basic view of an exemplary correlated trend display.

### DETAILED DESCRIPTION

The disclosure relates to a method for displaying changes in parameter values on a display, which can be executed with a low degree of expenditure on equipment and an apparatus for displaying changes in parameter values on a display.

On a given display, two successive sampled values of, in each case, two parameter values can be represented as oppositely directed vectors with a common origin on, and orthogonally to, a dividing line, which divides the display into two component areas. More recent sampled values and older (i.e., earlier) sampled values of each of plural parameters can each be plotted together on opposite sides of the dividing line on the same component area. That area which is enclosed by the dividing line and the connecting lines between the respectively older sampled value of a parameter value and the respectively more recent sampled value of the other parameter value can be represented in a highlighted form.

This resulting area can be triangular for all the parameter values which are different from zero, and the area points away from the dividing line in the form of an arrow. The tip of the arrow is formed by the point of intersection of the connecting lines between the respectively older sampled value of one parameter value and the respectively more recent sampled value of the other parameter value.

If the tip of the arrow is located in the component area of the more recent sampled values, the correlated trend of the two parameter values under consideration is rising. On the other hand, if the tip of the arrow is located in the component area of the older sampled values, the correlated trend of the two parameter values under consideration is falling. The area content of the enclosed area can be a measure of the weight of the trend.

In this context, a complex relationship of the correlated linking of two time profiles can be displayed with simple geometric means having low computing requirements.

According to an exemplary embodiment of the disclosure, each highlighted area is represented in a signal color.

In addition to the shape of the enclosed area, its color can also be highlighted. This increases the visual perceptibility of the correlated trend.

According to an exemplary embodiment of the disclosure, the highlighted areas can be represented in significantly different signal colors on each side of the dividing line.

This can increase the visual perceptibility of the trend direction of the correlated trend.

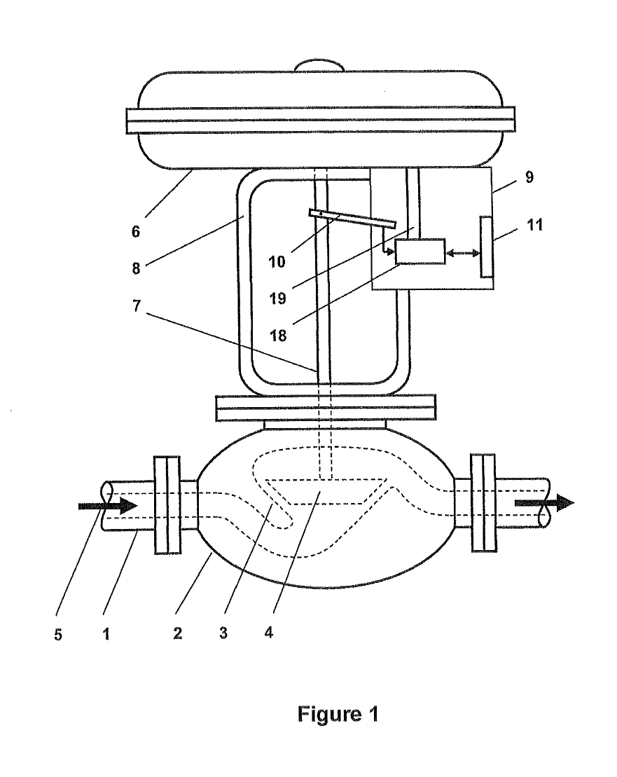

In FIG. 1, in a fragmentarily indicated pipeline 1 of a process engineering system (not illustrated further), a process valve 2 is installed as an actuator element. The process valve 2 has in its interior, a closing body 4 which interacts with a valve seat 3 and has a purpose of controlling the quantity of a process medium 5 passing through. The closing body 4 can be actuated linearly by a pneumatic actuator drive 6 via a push rod 7. The actuator drive 6 is connected to the process valve 2 via a yoke 8. A digital position controller 9 can be attached to the yoke 8. The stroke of the push rod 7 can be signaled to the position controller 9 via a position pickup 10. The detected stroke can be compared in an electronic control unit 18 with the setpoint value fed via a communication interface 11, and the actuator drive 6 can be actuated as a function of the determined control error. The electronic control unit 18 of the position controller 9 serves as an I/P converter for converting an electric control error into an adequate control pressure. The I/P converter of the position controller 9 can be connected to the actuator drive 6 via a pressure medium supply line 19.

The position pickup 10 can be connected to the rotational axis of a potentiometer in the position controller 9 and has an eyelet into which a driver on the push rod 7 engages. According to an exemplary embodiment, the position controller 9 can include a processor (e.g., a computer processor) which is configured to execute computer-readable instructions recorded on a non-transitory computer-readable recording medium, such as a non-volatile memory including a ROM, a hard disk drive, an optical memory, flash memory, etc., to perform any of the features described herein.

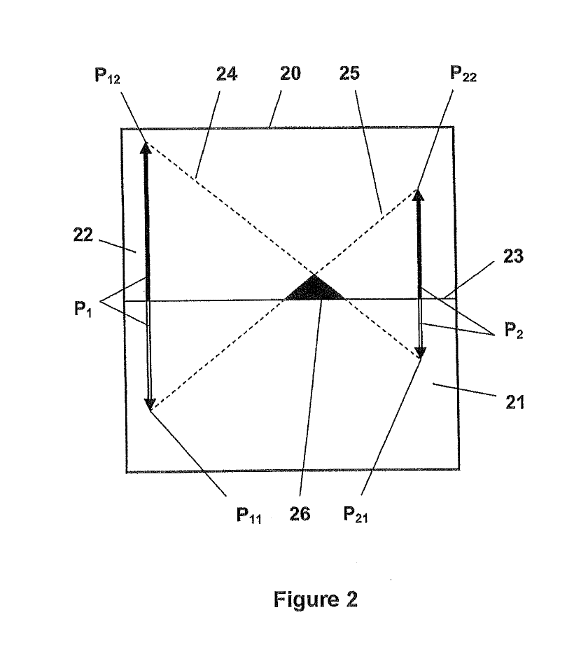

The position controller 9 has a display device whose essentially rectangular display 20 is illustrated in FIG. 2. The display surface 20 is divided into two component areas 21 and 22 by a dividing line 23.

In a first exemplary embodiment of the disclosure, the dividing line 23 can be arranged centrally on the display 20 and divides the latter into two component areas 21 and 22 with equal areas.

In an exemplary embodiment, the position of the dividing line 23 on the display 20 can be dependent on the ratio of the parameter values to one another.

In an exemplary embodiment, the dividing line 23 can be arranged horizontally on the display 20.

On the display 20, two successive sampled values P₁₁ and P₁₂ of a first parameter value P₁ and two successive sampled values P₂₁ and P₂₂ of a second parameter value P₂ can be represented as oppositely directed vectors with a common origin on the dividing line 23. All the vectors can be arranged orthogonally with respect to the dividing line 23.

The more recent sampled values P₁₂ and P₂₂ are plotted together on the component area 22, and the older sampled values P₁₁ and P₂₁ are each plotted together on opposite component areas 21. That area which is enclosed by the dividing line 23 and the connecting lines 24 and 25 between the respectively older sampled value P₁₁ and P₂₁ of the parameter value P₁ or P₂ and the respectively more recent sampled value P₁₂ and P₂₂ of the other parameter value P₂ or P₁ can be represented as a highlighted trend area 26.

The trend area 26 can be triangular for all those sampled values P₁₁ to P₂₂ of the parameter values P₁ and P₂ which are different from zero and points away from the dividing line 23 in the form of an arrow, wherein the tip of the arrow can be formed by the point of intersection of the connecting lines 24 and 25.

In one an exemplary embodiment of the disclosure, the trend area 26 can be highlighted in color. Use of signal colors is desirable. In particular, the representation of the trend area 26 in significantly different signal colors facilitates the visual assessment of the correlated trend. In this context, the trend area 26 which forms in the region of the first component area 21 can be represented in the color red and the trend area 26 which forms in the region of the second component area 22 can be represented in the color green.

The tendential development of the static friction of the process valve 2 can easily be seen through the inventive correlation of the transmission coefficient K_{P} of the proportional component of the controller for the opening direction of movement of the valve as first parameter values P₁ with the transmission coefficient K_{P} of the proportional component of the controller for the closing direction of movement of the valve as second parameter values P₂. In this context it is possible to provide that the trend area 26 can be represented in the signal color red when the static friction is increasing and in the signal color green when the static friction is decreasing.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Pipeline
2 Process valve
3 Valve seat
4 Closing body
5 Process medium
6 Actuator drive
7 Valve rod
8 Yoke
9 Position controller
10 Position pickup
11 Communication interface
18 Electronic control unit
19 Pressure medium supply line
20 Display
21, 22 Component areas
23 Dividing line
24, 25 Connecting lines
26 Trend area
P_{xy} Sampled values
Pₓ Parameter values

What is claimed is:

1. A method for displaying changes in parameter values on a display surface, comprising:
successively sampling two values for each of two parameters at a first earlier time and a more recent second time;
displaying the two successively sampled values of each parameter value as oppositely directed vectors having a common origin on, and orthogonal to, a dividing line which divides the display;
plotting the two more recent sampled values and the two earlier sampled values on opposite sides of the dividing line, and highlighting an area which is enclosed by the dividing line and connecting lines between the earlier sampled value of one parameter value and the respectively more recent sampled value of the other parameter value and a connecting line between the earlier sampled value of the other parameter value and the respectively more recent sample valued of the one parameter value.

2. The method as claimed in claim 1, comprising:
highlighting each area in a signal color.

3. The method as claimed in claim 2, comprising:
representing the highlighted areas in significantly different signal colors on each side of the dividing line.

4. An apparatus for sampling parameter values of a processing system, comprising:
a sampling device which successively samples two values for each of two parameter values at a first earlier time and a later second more recent time;
a display for displaying the two successively sampled values of each parameter value as oppositely directed vectors having a common origin on, and orthogonal to, a dividing line which divides the display wherein the two more recent sampled values and the two earlier sampled values are plotted on opposite sides of the dividing line, and an area which is enclosed by the dividing line and a connecting line between the earlier sampled values of one parameter value and the respectively more recent sampled value of the other parameter value and a connecting line between the earlier sampled value of the other parameter value and the respectively more recent sample valued of the one parameter value.
